(19) United States
(12) Patent Application Publication
(10) Pub. No.: US 2004/0234728 A1
(43) Pub. Date: Nov. 25, 2004

(54) Method for producing carboard and cardboard product

(76) Inventors: Hannu Suksi, Lohja as (FI); Isko Kajanto, Espoo (FI); Jorma Mattila, Kangasala (FI); Taisto Rintamaki, Kangasala (FI)

Correspondence Address: Kubovcik & Kubovcik, The Farragut Building, 900 17th Street N W, Suite 710, Washington, DC, 20006, US

(21) Appl. No.: 10/482,774

(22) PCT Filed: Jun. 26, 2002
(86) PCT No.: PCT/FI02/00567

(30) Foreign Application Priority Data
Jul. 5, 2001 (FI) 011479

(51) Int. Cl. B32B 1/00

(52) U.S. Cl. 428/174; 156/210

(57) ABSTRACT

A method is disclosed method for manufacturing a cardboard product comprised of at least two layers, the method comprising the step of bonding the separate webs of paper or cardboard by an adhesive into a combination product. At least one of the webs is worked mechanically by embossing so that the permanent deformations appear projecting outwardly from at least one surface of said at least one web to a height not making the web thickness to exceed 3 mm. The method is further applicable to the manufacture of a cellulosic-fiber-containing cardboard or paper product for manufacturing a multilayer cardboard grade comprising at least two adhesively bonded layers, whereby the product is worked mechanically so as to make permanent three-dimensional deformations on the product material to a height not making the product thickness to exceed 3 mm.

The invention relates to a method according to claim 1 for manufacturing a multilayer cardboard.

The invention also relates to a cardboard product suited for use as the middle web of a cardboard.

Cardboard is used as a printing substrate and most typically for making different kinds of packages. In packaging cardboards, important qualities are the strength and stiffness of the packaging material, and, if the surface of the package is to be printed with text or pictures, a sufficiently high quality of the printing substrate. Frequently, cardboards are also provided with impermeable barrier layers if they are used, e.g., for packaging liquids or products containing volatile components, such as coffee and other foodstuff. The surface quality of the printing substrate is determined by the requirements set on the quality of print on the product package, whereby luxury products obviously must be packaged in materials different from those used for shipping and consumer packages of bulk goods.

To make a cardboard sufficiently stiff, the cardboard must be produced rather thick, whereby a lot of raw material fiber stock is needed for manufacturing the cardboard. On the other hand, the higher the requirements set on the performance of the printing substrate, the more expensive raw materials must be used to render the product a sufficiently good brightness among other qualities. As the stiffness of cardboard is chiefly determined by its thickness, the specific material consumption and the raw material costs increase almost as a linear function of the product thickness and basis weight. Accordingly, it would be advantageous to have the liner of the cardboard made from a strong material of high density and good printing properties while the middle web should have a low density. Conventionally, the density of the cardboard web is essentially constant over its entire cross section, because normal manufacturing techniques are incapable of producing a web with a substantially varying density across its thickness dimension. While folding cardboards do have a different density in the surface layer as compared to the density of the middle web, even in these grades the variation in density is so small that there is no as effective way of reducing the material consumption of a thick cardboard as that offered by corrugated boards having a fluted middle web. Hence, corrugated board is still preferred in the manufacture of packages due to the increasing demands on stiffer packaging materials.

Corrugated board is a layered product comprising two outer layers called liners and a corrugated middle web known as fluting placed therebetween. In multilayer corrugated boards, the number of fluted middle webs may be greater than one, and the middle webs are separated from each other by planar cardboard layers similar to those forming the liner layers. While the shape, intercrest spacing and height of the flutes may vary, the crests of fluting are invariably oriented in a perpendicular direction to the machine direction of the raw material webs. Since the entire web used in the middle layer is fluted without deforming the smooth surface continuity of the web sides, the fluted crests form linear and continuous bonding patterns on the surface whereto it will be glued. As a result, the rigidity of the middle layer becomes different in the lateral and longitudinal directions. In cardboard webs, the fibers orient themselves during web manufacture chiefly in the machine direction, that is, in the longitudinal direction of the web. As a result, the strength properties of the web become different in the cross-machine and machine directions. In a corrugated board, this difference is equalized by the greater stiffness of the middle layer in the direction of the flutes. Herein, the term “direction of flutes” is used in the meaning of the longitudinal direction of the crests and valleys of the flutes.

Although corrugated board is an advantageous packaging material, however, it has several shortcomings. The compressive strength of corrugated board varies in a wide range depending on whether the compressive force is imposed on a crest or a valley, and, furthermore, liner layers are not necessarily planar at all points, but they may have deformations caused by such factors as minor shrinkage after gluing, for instance. Of course, the surface layer properties of corrugated board are dependent on the thickness and quality of the liner board, but nevertheless corrugated board is not generally considered to be a material of choice for processing with contacting printing methods, which curtails its use in premium-quality packages. While corrugated board grades as a rule also tend to be relatively thick, recently thinner corrugated boards with lower basis weights have already been introduced commercially. The excessive thickness of this material limits its use in both printed products and small retail packages that are limited by their external dimensions. Accordingly, corrugated board does not usually serve as an alternative to cardboard at least in packages of premium quality.

In U.S. Pat. No. 5,374,468 is disclosed a combined board product, wherein the middle web of a board product comprised of three layers is embossed double-sidedly by passing a wet cardboard web over apertured vacuum drums. The wet web conforms to the apertures of the vacuum drum which that form cup-like embossments on the web, whereby the embossments appear on the other side of the web as dimples. Inasmuch the web is treated by vacuum, it must be processed in a wet state thus requiring postdrying after the embossing process. On the other hand, as the dimples must be relatively large and high, it is difficult to utilize this method for making thin and printable cardboard.

It is an object of the present invention to provide a method suited for manufacture of a cardboard incorporating a certain kind of middle web, whereby the cardboard offers good stiffness and a ratio of raw material consumption to board stiffness lower than that of prior cardboard grades.

The goal of the invention is achieved by combining the cardboard from at least two, advantageously three layers adhered by adhesive areas to each other, and through working the material of the middle web in a dry state, prior to the application of the adhesive, so as to obtain permanent deformations whose tips project from the middle web surface so that the thickness of the middle web is not thicker than 3 mm.

More specifically, the middle web according to the invention is characterized by what is stated in the characterizing part of claim 1.

Furthermore, the assembly according to the invention is characterized by what is stated in the characterizing part of claim 10, while the cardboard product according to the invention is characterized by what is stated in the characterizing part of claim 12.

The invention offers significant benefits.

The invention makes it possible to produce high-quality, printable packaging grades of cardboard, wherein the ratio of stiffness to specific consumption of raw material, particularly of fibrous raw material, is substantially more advantageous than in conventional cardboard grades. The properties of the cardboard are easy to vary and it may also be produced in extremely lightweight grades. The bulk of the product is high, as well as its strength and flexural resistance in regard to its basis weight. In fact, the stiffness of the product can even exceed that of corrugated board. Conversely, in comparison to a product of equal stiffness and strength, the cardboard manufactured according to the invention can be made using a smaller amount of fibrous stock. Hence, the novel cardboard grade is more cost-effective to manufacture and it imposes a lower environmental load than that of a conventional cardboard in which all plies are solid layers. The product is completely and readily recyclable provided that all layers of the product are made from a plant fiber material. If the product requires moisture or gas barriers, these can be readily implemented using conventional foil/film materials. Herein, the recyclability of the product is dictated by the type of foil/film used, whereby in favor of recyclability it is advantageous to select foil/film materials that are recyclable in conjunction with the fibrous stock.

The properties of the cardboard can be varied in multiple ways. By virtue of varying shape and dimensions of the deformations formed in the middle web, it is possible to control, not only the thickness of the final product, but also its strength qualities in different directions, while the liner qualities can be varied to obtain desired printing properties of the cardboard. The cardboard liner can be, e.g., a coated and calendered grade thus rendering the product good printing properties. As the thickness profile of the cardboard is controlled smooth and the compressive resistance of the cardboard in a direction perpendicular to its surface is uniform, the novel cardboard can be printed at a high quality using conventional contacting-type printing techniques such as offset, flexographic and digital printers, for instance.

The properties of the cardboard can be affected by the shape of the middle web deformations. Inasmuch paper and cardboard webs tend to inherently become slightly two-sided due to their manufacturing techniques, these differences may be equalized or enhanced by selecting a single-sided or a double-sided deformations. The deformations can have closed patterns and located such that they do not form any regular grids or straight lines along which the web material could collapse under stress. Advantageously, the shape of the deformations is selected such that keeps the projecting tips and edges maximally intact during processing thus ensuring good strength of the middle web. On the other hand, the adhesive used for adhering the different web layers to each other performs as a repairing component that heals possible tears particularly at the tips of formed projections. As to the resistance of the deformations to tear, it is appreciated that round and curved shapes are more advantageous than cornered shapes. The most advantageous shape is a rounded deformation as it gives a good strength and is least stressing to the web being worked.

In the following, the invention will be examined in more detail by making reference to embodiments discussed in the text.

In Finnish patent application 20001799 is disclosed a cardboard product comprised of a middle web and linerboards, as well as a method for manufacturing the same. In this method, the middle web is worked by pressing projections thereto and then bonding the different webs of the cardboard by an adhesive to each other. As the present invention relates to the method and product described in cited patent application, a short description of the method is included herein. Further details of the disclosure can be found in cited patent applications incorporated in this patent application as reference.

The manufacture of a three-layer product needs three webs that are imported to the manufacturing process in rolls. The caliper of the webs can be selected rather thin when the method is used to produce thin grades of printable cardboard. Hence, the raw material webs are more of the paper variety than cardboard. The process starts by unwinding a suitable length of web from the raw material rolls and is completed when the webs are passed to a bonding/calibrating nip formed between two rotary rolls. The webs are joined in this final nip. Initially, the middle web is worked in a roll nip with a raised surface pattern by pressing the web in a dry state so as to obtain permanent deformations on the web surface. In this context, a dry web must be understood as having the normal moisture content of a web being paid off from a storage or machine roll, that is, the delivery moisture content of the web roll, typically less than 10%, generally 3 to 12%. Furthermore, the pressing operation is performed without subjecting the web to heating or steaming. Most advantageously, the web surface is pressed with a three-dimensional pattern such as a pattern formed by truncated cones, semispherical or honeycomb cup shapes, whereby the strength of the web after pressing both in the orientation direction of the fibers and in the cross-machine direction is equally good, which is not the case in a two-dimensional fluted medium of corrugated board, for instance. The liner webs are passed over adhesive applicator rolls. The function of these is such that the roll running on the exterior side of the liner web serves as a backing roll, while the adhesive is applied to the interior sides of the liner webs on the surface of an applicator roll. The adhesive may also be applied to the tips of the pressed projections made to the middle web, whereby the adhesive application system is different and may comprise an adhesive applicator nip of the above-described kind adapted along the travel of the middle web. Next, the adhesive-coated liner webs are passed with the worked middle web through the bonding nip, where the webs adhere to each other and, simultaneously, the thickness of the cardboard is calibrated by pressing the web between the rolls. In this fashion, the combination of webs and bonding thereof into a product can be made in a single step, wherein also the thickness calibration of the cardboard product takes place. The bonding nip also serves as the draw nip for the webs. After bonding, the product can be dried if necessary depending on the curing requirements of the adhesive used. Of course, the adhesive can be cured using other types of reactions as dictated by the adhesive applied to the web.

The invention is directed to the manufacture of cardboard for low-cost consumer packages, whereby the goal of the invention is to cut down the specific consumption of raw materials used for the package. To this end, the present cardboard is specified as a multilayer packaging grade cardboard typically having a basis weight of 100 to 500 g/m². The thickness of the product is typically 0.5 to 1.5 mm making the product compatible with a variety of different printing techniques. A thicker product such that can be attained using a middle web worked to, e.g., 3 mm thickness, can be used in printing methods that are not limited as to the thickness of the sheet or the web to be printed.

The advantage of the middle web according to the invention is based on the concept that the middle web is patterned with plentiful small-size projections having a relatively low height of pressed projection tips. The most significant factor of such patterning is the height of the projections that should make the middle web thickness not larger than 3 mm. However, the projections need not cover a very large net area of the middle web overall surface area provided that a sufficiently large number of points or areas supporting the liner web are made. Hence, the proportion of projections may vary from 5 to 70% of the overall surface area of the middle web. Herein, the surface area of the middle web is defined as the area of the unpressed virgin middle web, while the area of pressed projections must be understood as the overall projectcd area of the pressed patterns in the plane of the middle web. If both surfaces of the middle web are pressed, it is obvious that the summed area of projections on both sides cannot exceed the overall surface area of the virgin middle web. Naturally, the number of pressed points per unit area is dependent of the size and shape of the projections. According to the invention, the number of projections should be greater than 0 but less than 50 per cm². Inasmuch the area of an endless pressed pattern such as different curves may cover several square centimeters, in the present context it is appropriate to consider each part of an individual curve falling within the unit area of a sample measurement as a separate projection. The distance between the crest walls of the curved projections should not be excessively large, because otherwise the load-bearing capability of the cardboard in the areas between the crest walls is reduced. According to a common rule of thumb in the art, the average distance between the opposite crest walls of a projection at any point of the pressed pattern should not be greater than 3 mm. The average wall-to-wall distance must be understood as the average distance measured at different heights of the projections in a plane parallel to the web surface. For a circular or conical projections, this means a diameter of 3 mm. For a linear, curved or meandering projections, the distance between the opposite walls is measured at the edges of the raised crest. This distance measurement is taken in the plane of the raised side of the web. The slope angle of the pattern walls from the base level of the web may vary widely, but it should preferably be 20° to 90°. This slope angle is determined by aligning a virtual line along the web surface wherefrom which the pattern is pressed and another line tangentially along the inner wall of the indented pattern. For spherical or otherwise curved shapes, the average slope angle may be used. To make the product sufficiently thin for use in a printing machine and to reduce the specific raw material consumption of the finished product, the base sheet of the middle web should not be excessively thick. Practical tests performed in conjunction with the present invention have shown that a base sheet not thicker than 200 μm may be advantageously used. As these dimensions are affected by the dimensional recovery that takes place after pressing, the measurements must be taken from an pressed but relaxed material.

Although an deformations leaving a spherical or truncated-cone indent with a circular perimeter on the deformed side of the middle web is most advantageous used as by causing least stress to the fiber and involving lesser risk of torn web material, also any other pattern may be contemplated without departing from the scope and spirit of the invention, such as circular-top, elliptical, polygonal or the like desired pattern. However, the more complicated the pattern shape the more expensive is the pressing tool to fabricate. While the web is most advantageously worked by an pressing roll, the invention may be implemented using any kind of mechanical working methods that employ a single pressing tool or a plurality of thereof. The tool or its operating trajectory should be such that straight lines between the pressed patterns are avoided at least in the machine and cross-machine directions. If the patterns are pressed by means of knobs aligned in linear arrays, the linear arrays of the pressing knobs must be aligned differently from the machine direction, preferredly at about −45° and +45° angles relative to the cross-machine direction.

In addition to those described above, the invention may have alternative embodiments.

The middle web is advantageously worked in a dry state. To improve its workability, the web may be heated with the help of rolls, radiant heaters and hot-air blowing or heated/moistened by steam injection. The amount of injected steam is advantageously kept such that the moisture absorbed by the web is evaporated from the hot web without postdrying. If a more drastic amount of moisture or possibly even wetting with water is desired, postdrying is often mandatory. This, however, elevates the investment costs and specific energy consumption of the machinery. The middle web is at least for its basic part comprised of a plant fiber web. While also the middle web can be coated, calendered and treated with web improvement agents, these treatments give a better end result when made to the liner webs. In fact, surface sizing of the middle web or bulk sizing of the stock used for making the same is a more efficient technique for improving the middle web strength. All known fillers and additives can be used in the stock of the middle web, and the stock flow may comprise one or more stock compositions originating from different fiber sources or be manufactured using different processes. This option may be utilized for controlling the web strength through mixing shorter and longer fiber in the middle web manufacture.

Layered product structures comprising a middle web and at least one liner web may be combined into multilayer structures of desired thickness.

1.-14. (canceled).

15. A method for manufacturing a printable cardboard product comprised of at least two layers, the method comprising a step of bonding separate webs of paper or cardboard by an adhesive into a combination product, characterized in that at least one of the webs is worked mechanically by pressing so that permanent deformations appear projecting outwardly from at least one surface of at least one web to a height not making the web thickness to exceed 3 mm and the average slope angle of the wall of a given pressed pattern from the base web surface is 20° to 90°.

16. The method of claim 15, characterized in that the number of deformation patterns made by pressing is greater than zero but less than 50 per cm².

17. The method of claim 15, characterized in that the web subjected to mechanical working is treated in a dry state having a moisture content advantageously less than 12%.

18. The method of claim 15, characterized in that the adhesive is applied to the tips of the projections on the pressed web.

19. The method of claim 15, characterized in that the average distance between the opposite crest walls of a given pressed pattern is not greater than 3 mm.

20. The method of claim 19, characterized in that the material thickness of the middle web is not greater than 200 μm.

21. The method of claim 15, characterized in that layered structures comprised of at least one middle web and one liner web are combined into a multilayer structure of a desired thickness.

22. A web-like cardboard or paper product comprising plant fibers suited for manufacturing a multilayer printable cardboard grade comprising at least two adhesively bonded layers, characterized in that the product is worked mechanically so as to make permanent three-dimensional deformations on the product material to a height not making the product thickness to exceed 3 mm and the average slope angle of the wall of a given deformation pattern from the base web surface is 20° to 90°.

23. The cardboard or paper product of claim 22, characterized in that the number of deformation patterns is greater than zero but less than 50 per cm².

24. The cardboard or paper product of claim 22, characterized in that the average distance between the opposite crest walls of a deformation pattern is not greater than 3 mm.

25. The product of claim 22, characterized in that the material thickness of the product is not greater than 200 μm.

26. The product of claim 22, characterized in that the proportion of the worked area in regard to the overall area of the web in the product is 5 to 70%.
